(19) United States
(12) Patent Application Publication
(10) Pub. No.: US 2016/0053203 A1
(43) Pub. Date: Feb. 25, 2016

(54) SYNERGISTIC MIXED SOLVENTS-BASED COMPOSITIONS FOR REMOVAL OF PAINT, VARNISH AND STAIN COATINGS

(71) Applicant: KOLAZI S. NARAYANAN, WAYNE, NJ (US)

(72) Inventor: KOLAZI S. NARAYANAN, WAYNE, NJ (US)

(21) Appl. No.: 14/830,436

(22) Filed: Aug. 19, 2015

Related U.S. Application Data
(60) Provisional application No. 62/039,916, filed on Aug. 21, 2014.

(51) Int. Cl. C11D 3/20; C11D 3/16; C11D 3/28

(52) U.S. Cl. CPC C11D 3/2096; C11D 3/28; C11D 3/2093; C11D 3/162

(57) ABSTRACT

Compositions and methods are disclosed which are effective for removing or stripping varnish and paint or stains from surfaces such as wood or metal which comprises activating NMP and/or BLO with 1-20% by weight of ethyl 3-ethoxypropionate (EEP), preferably 2-15%, and optimally about 3-5%, and with 0.1-10% by weight of NOP/ALC EO, preferably 0.2-5%, most preferably 1 -3% by weight and/or 0.1-5% by weight of Silwett 77, preferably 0.2-3%, and most preferably 0.5-2% by weight,

### BACKGROUND OF THE INVENTION

1. Field of the Invention

This invention relates to non-aqueous paint and varnish remover compositions, and more particularly, to a method of activating NMP and/ or BLO for more effective paint and varnish removing action, including components used in aqueous cleaning compositions thereof.

Additional attributes of the inventive compositions are nonflammable, biodegradable, environmentally benign for industrial and consumer use, easy washability, and compatible with existing commercial paint stripping compositions and/or components.

2. Description of the Prior Art

The term ‘varnish and paint remover’ as applied herein refers to chemical con positions which can strip or facilitate stripping of coatings, such as, paint, varnish, lacquer, shellac, polyurethane finishes and enamels, used to protect substrates such as wood and metal and to beautify them. Methylene chloride paint strippers are currently the industry standard for stripper performance. Methylene chloride strippers are effective for quickly softening most types of paints. The speed at which methylene chloride performs is believed to be due to its high solvent power coupled with high volatility as reflected by its extremely fast evaporation rate. This high volatility shortens the work life of methylene chloride paint strippers. Frequently, when methylene chloride paint strippers are used on thick accumulations of paint, more than one application is required since the work life is insufficient to permit penetration through the accumulation of paint. Methylene chloride is a chlorinated solvent which is closely regulated for environmental protection. Recently, it was discovered that methylene chloride can cause tumors in rats and mice. Since that discovery, the wide use of that solvent by industry and consumers has come under close scrutiny by federal regulatory agencies. N-methyl-2-pyrrolidone (NMP) has been employed in place of methylene chloride as the active ingredient in paint stripper compositions. Nelson, in U.S. Pat. No. 4,759,510, (Incorporated herein by reference in its entirety) for example, described a composition for this use having low volatility which included about 20% to 90% by weight of NMP and 30% to 70% by weight of an aromatic hydrocarbon solvent.

Mixtures of NMP and gamma-butyrolactone (_{BLO}) also have been used as liquid formulations for removing screen printing inks. Madsen, in U.S. Pat. No. 4,836,950 (Incorporated herein by reference in its entirety), for example, described a liquid composition which included 1-25% by volume of NMP and/or BLO. Valasek, similarly, in U.S. Pat. No, 4,664,721(Incorporated herein by reference in its entirety), described a composition which included 30-85% by weight of NMP and 10-35% by weight of an oxygenated solvent selected from esters and ethers. BLO was mentioned as a suitable component (lactone), although butoxyethanol and cyclohexanone were preferred. Caster, in U.S. Pat. No. 4,865,758 (Incorporated herein by reference in its entirety) described a method of removing paint with a lower alkyl substituted 2-oxazolidinone. In comparative results reported therein, it was disclosed that ethyl 3-ethoxypropionate had no effect on paint removal. McCullins, in British 1,487,737, described a paint remover composition for aerosol type paints in the form of a gel which included methyl ethyl ketone, ethyl acetate, ethoxyethanol and 2-ethoxyethyl acetate. This mixture of solvents was considered effective for paint sprayed graffiti as a viscous, transparent gel containing particles of silica or alumina in suspension. Palmer, in U.S. Pat. No. 4,120,810, (Incorporated herein by reference in its entirety) described paint remover compositions of NMP and/or BLO, and at least 36 mole % of blends of alkyl naphthalenes and alkyl benzenes.
These and other compositions, however, have not proven particularly effective for removing paint and varnish from wood and metal surfaces, without containing objectionable halogenated or aromatic compounds. Furthermore, they do not possess the attributes of being biodegradable, non-flammable, having a low vapor pressure and low toxicity.
Narayanan et al in U.S. Pat. No 5,098,592 (Incorporated herein by reference in its entirety) (World patent No 5217640) have shown that a synergistic combination of NMP, BLO and ethyl 3-ethoxypropionate (EEP) is a very effective composition for removing varnish and several type of paints from wood and metal substrates.
In Narayanan et al in U.S. Pat. No. 5,154,848 (Incorporated herein by reference in its entirety). A composition in which NMP is replaced by components A B or C as described herein below.
A composition in which BLO is replaced by components A, B or C.
A=Rhodiasol Polarclean (Pentanoic acid, 5-(dimethylamino)-4-methyl-5-oxo-methyl ester (Rhodiasoln R polarclean)
B=Propylene Carbonate
C=N,N dimethyl imidazolidinone (DMI)

Fusiak in U.S. Pat. No. 5,334,331 (incorporated herein by reference in its entirety) describes compositions of NMP/BLO and combinations activated by cyclomethacone at around 5% to remove organic coatings from substrates,
Fusiak et al in U.S. Pat. No. 5,049,300 (Incorporated herein by reference in its entirety)describes activation of NMP and combinations with acids
Known art of solvent based compositions for removal of paint, varnish coatings are non-aqueous, essentially free from water.
Several water based cleaning and spray compositions use powerful wetting agents and spreading agents. See: Robert Login et at on NOP use in multipurpose applications described in WP 88/00184, U.S. Pat. No. 5,294,644 (Incorporated herein by reference in its entirety) and U.S. Pat. No. 5,093,031 (incorporated herein by reference in its entirety). Narayanat et at on synergy between NOP and Silwett L 77 (ethoxylated silicone) described in U.S. Pat. No. 5,508,249 (Incorporated herein by reference in its entirety), Rosen et al synergy between NOP and Alcohol ethoxylate, in U.S. Pat. No. 7,264,885 (Incorporated herein by reference in its entirety) and Narayanan et al (water dilutable NOP, alcohol ethoxylate synergistic composition, Easy wet 20) in U.S. Pat. No. 6,967,190 (Incorporated herein by reference in its entirety), It is the object of this invention to enhance performance of essentially non-aqueous synergistic solvent mix to remove paint, varnish, and stain coatings from substrates. This objective is accomplished by including very effective wetting and spreading agents normally used for aqueous systems in small concentrations. These and other objects and features of the invention will be made apparent from the following description of the invention.

The choice of wetting and spreading components have the following criteria.
1. Solvent-surfactant in one product
2, Estimated or measured HLB less than 8, preferably less than 6
3. Efficient wetting demonstrated by brave's wetting of cotton skein with less than 5 seconds at 0.1% in water.
4. Equilibrium surface tension less than 30 mN/M (dynes/cm) at 0.1% in water
5. Contact angle in Teflon at less than 50° with 0.1% aqueous solution
6. Solvent action on most adhesive polymers
7. Total compatibility with the pre-evaluated synergistic solvent matrix
8. Water washable on dilution
9. Desirable synergy with the chosen spreading agent
10. Spreading agent—low equilibrium surface tension as above
11. Contact angle as above
12. Synergy with the chosen wetting agent
13. Water washable on dilution
14. Total compatibility with the pre-evaluated synergistic solvent matrix

The Advantage of including the inventive wetting agent and/or spreading agents along with essentially non-aqueous solvent matrix is to provide efficient spreading and wetting through the pores of the coated substrates and improve speed and completeness of the coating removal. Inclusion of the inventive components would also provide efficient removal of residual solvent matrix from the substrate during the post stripping washing process.

The Inventive compositions enable:
High lifting capability of varnish/paint type coating from substrates individually or along with commercial paint stripping compositions
Easy post-stripping washability for efficient removal of the inventive components from the substrate using water or common cleaning solvents like lower alcohols like ethanol, isopropanol (methanol will work but has environmental issues)

Typical such wetting and spreading agents but not limited to are described below: NOP Alcoxylated (ethoxylated or propoxylated long alkyl chain (≧C8 preferably >C10) alcohol Alcoxylated silicone (ethoxylated siloxan). Following illustrations make use of N-Octyl pyrrolidone (NOP); Nonynol ethoxylate with average 3 EO: Silwett L 77 and combinations thereof.

### SUMMARY OF THE INVENTION

A method is provided herein which is particularly effective for removing or stripping varnish and paint or stains from surfaces such as wood or metal which comprises activating NMP and/or BLO with 1-20% by weight of ethyl 3-ethoxypropionate (EEP), preferably 2-15% and optimally about 3-5%, and with 0.1-10% by weight of NOP/ALC EO, preferably 0.2-5%, most preferably 1-3% by weight andior 0.1-5% by weight of Silwett 77, preferably 0.2-3%, and most preferably 0.5-2% by weight. [The actual optimum ratio of BLO/cosolvent/EEP may be experimentally determined].

In a suitable embodiment of the invention, the activated composition herein includes about 20-70% NMP, 30-80% BLO and 1-30% EEP, 0.1-10% NOP and 0.1-5% Silwett L 77 (Ethoxylated siloxane) preferably 30-65% NMP, 35-70% BLO and 2-15% EEP, 0.2-5% NOP and 0.2-3% Silwet L 77 and optimally, 35-39% NMP, 55-59% BLO and 3-5% EEP and 1-3% NOP and0.5-2% Silwet L 77.

The method of the invention provides activation for NMP or NMP replaced solvent (described in a co-pending case) and BLO and a synergistic effect for paint and varnish removal with less material than used previously with other related compositions, and in a safe and environmentally acceptable manner.

### DETAILED DESCRIPTION OF THE INVENTION

Typical paint and varnish remover compositions of the present invention include the following components.

TABLE 1
Typical Paint Stripping Compositions, Wt % (NEW)

| | | | | WETTING | SPREADING |
|---|---|---|---|---|---|
| | | | Activator | AGENT (NOP)/ | AGENT |
| Solvents | BLO | NMP | (EEP) | (ALCEO)* | (Silwett L 77) |
| Essential | 20-80 | 10-90 | 1-20 | 0.1-10 | 0.1-5 |
| Suitable | 30-70 | 20-70 | 2-15 | 0.2-5 | 0.2-4 |
| Optimum | 40-60 | 30-40 | 1-5 | 0.5-3 | 0.5-3 |
| Preferred | 50-55 | 32-38 | 1-4 | 1-1.5 | 0.5-1 |

A commercial optimized wetting composition Easy Wet 20 can also be used in the place of wetting agent
*Ethoxylated (3 EO) nonynol,
**Ethoxylated siloxane

Other Co-solvent and activators combinations as defined in copending application would also work. Acids/Bases/silicones can also be used as additional activators.

Optional suitable components (% by Wt.) Optimum/Preferred are shown below:

TABLE 2
Optional Suitable Components, Wt %

| Components | Optimum | Preferred |
|---|---|---|
| Surfactants | 0-5 | 2-3 |
| Organic acid | 0-5 | 2-3 |
| Rheology modifoer | 0-2 | 0.5-1.5 |
| Flavoring Agent | 0-0.5 | 0-0.2 |
| Bittering Agent | 0-0.05 | 0.002-0.003 |
| Diluent | 0-40 | 10-30 |

As described in Table 1, the essential components of the paint and varnish remover composition of the invention include synergistic mixed solvents: NMP/BLO (available from commercial sources) which are activated by ethyl 3-ethoxypropionate (EEP). The activator compound EEP is available from Eastman chemicals as Ektapro® EEP solvent. The presence of EEP in the composition activates the solvents so that more effective paint and varnish removal action is achieved. Since EEP reduces the flash point of the composition, which is not desirable, it is preferred to use the lower end of the suitable range of the activating effect of EEP. NOP, ALC EO, and SILWETT L 77 are also available from commercial sources.

The composition of the present invention may contain optionally, one or more of the group of a surfactant, a thickener, a fragrance, a bittering agent and a diluent. Suitable surfactants include non-ionic surfactants with HLB ranging from about 8-18, selected from:
1. The polyethylene oxide condensates of alkylphenols, e.g., the condensation products of alkylphenols or dialkyl phenols wherein the alkyl group contains from about 6 to about 12 carbon atoms in either branched chain or particularly straight chain configuration, for example, octyl cresol, octyl phenol or nonyl phenol, with ethylene oxide, the said ethylene oxide being present in amounts equal to about 5 to about 25 moles of ethylene oxide per mole of alkylphenol.
2. Partial esters formed by the reaction of fatty acids, for example of about 8 to about 18 carbon atoms, with polhydric alcohols, for example, glycerol, glycols, such as, mono-, di-, tetra- and hexaethyleneglycol, sorbitan, etc.; and similar compounds formed by the direct addition of varying molar ratios of ethylene oxide to the hydroxy group of fatty acids.
3. The condensation products of fatty acid partial esters with ethylene oxide, such as, fatty acid esters of polyoxyethylene sorbitan and sorbitol containing from about 3 to about 80 oxyethylene units per molecule and containing fatty acid groups having from about 8 to about 18 carbon atoms.
4. The condensation products of aliphatic alcohols having from about 8 to about 18 carbon atoms in either straight chain or branched chain configuration, for example, oleyl or cetyl alcohol, with ethylene oxide, the said ethylene oxide being present in amounts equal to about 30 to about 60 moles of ethylene oxide per mole of alcohol.

Examples of surface active agents which may be Bused are hose supplied under the following trade names with approximate Chemical Constitution:

Antaron® monocarboxyl cocoimidazoline
Igepon® alkyl sulfoamides
Alipal® ammonium salt of ethoxylate sulfate
Igepal® ethoxylated alkylphenol

### Emulphogene®

tridecyloxypoly(ethyleneoxy)ethanol
Span 40® sorbitan monopalmitate
Parasyn® hydrogenated castor oil

### Miraniol®

cocoamphodipropionate
Trydet® polyethoxylated fatty acid ester

Suitable organic acids include but not limited to: Formic acid, Sulfonic acid (alkyl sulfonic acid), aryl sulfonic acid, alkyl/aryl phosphoric acid. It is preferred to use strong acids for most effectiveness, preferred pka 2-3, preferably <3.

Thickeners may also be included in the inventive composition: The preferred thickeners or gelling agents are cellulose derivatives which have the property of both water and organic solvent solubility. Cellulose derivatives of this type which are of particular interest are those ether derivatives containing etherifying groups selected from hydroxyalkyl groups and groups derived therefrom, such etherifying groups containing preferably up to about 5 or 6 carbon atoms. The gelling agent may also comprise cellulose ether derivatives which, in addition to etherifying groups selected from hydroxyalkyl groups and groups derived therefrom, contain other types of etherifying groups, especially small alkyl groups of, for example, one or two carbon atoms. However, such etherifying groups generally confer properties upon the cellulose derivative which are less acceptable for the present purpose, and the gelling agent is therefore conveniently substantially restricted to cellulose ether derivatives containing etherifying groups selected from hydroxyalkyl groups and groups derived therefrom.

Etherifying groups consisting of or derived from hydroxyalkyl groups containing up to 5 carbon atoms, particularly, 2, 3 or 4 carbon atoms, are of especial value. The hydroxypropyl celluloses, for example, have been found to be of particular value in giving a substantially transparent gel system with a suitable solvent system and in imparting quite adequate thickening and film-forming properties in their own right without the need of any other agents for these purposes. Conveniently, the hydroxypropyl group in such celluloses is derived from isopropanol rather than n-propanol but a number of variations in structure are possible even when this is the case. Thus, not all of the free hydroxy groups of the cellulose need necessarily be substituted and, if desired, the hydroxy groups of certain hydroxypropyl groups may, in turn, be substituted by a further hydroxypropyl group (as for example, in the klucel® materials described below). Hydroxypropyl celluloses employed in compositions according to the present invention conveniently have molecular weights in the range from about 50,000 to about 1,000,000, preferably from about 800,000 to 1,000,000.

One form of hydroxypropyl cellulose which has been used with advantage is marketed under the trade name Klucel H. Klucel® H has a similar chemical structure to Klucel® MS 3.0, which may also be used, but is of higher molecular weight, and possesses particular advantages in terms of the viscosity of its solutions. Thus, a 1% solution of Klucel® H in water has a viscosity in the range from 1,500 to 2,500 units and in ethanol the range is 1,000 to 2,500 units while solutions of Klucel® MS 3.0, particularly in ethanol, have a lower viscosity. The property of possessing a substantially similar viscosity in organic solvent and aqueous solutions is a valuable one for gelling agents used in compositions according to the present invention. The proportion of gelling agent required in the compositions in order to give good gels, depends in part on the molecular weight of the gelling agent used, the usual range being from 0.25% to 2%. Thus, for example, with the usual proportion of gelling agent of from about 0.25% or 0.5% upwards is suitable for high molecular weight materials and of from about 2% upwards is suitable for low molecular weight materials. For high molecular weight materials, for example of molecular weights of 800,000 to 1,000,000, a proportion of above 1.5% is preferably avoided as it leads to a gel of too great a viscosity. With low molecular weight materials, larger proportions may be used before such a position is reached and, if the molecular weight is low enough, amounts of up to 10% or even 20% or more may be used. It will be appreciated, however, that the use of a smaller amount of material of higher molecular weight is generally to be preferred.

A typical fragrance is oil of wintergreen (methyl salicylate) although many others known in the art may be used as well.

Suitable diluents include organic hydrocarbons such as dipentene and xylene, alkylene glycol ethers such as propylene glycol monomethyl ether, tnpropylene glycol monomethyl ether, dipropylene glycol monomethyl ether and tetrahydrofurfuryl alcohol, and propylene carbonate. Mixtures of these compounds also may be used. A suitable tittering agent is denatonium benzoate although others known in the art may be used as well.

Representative (preferred) corn positions of the invention include the following Examples below:

TABLE 3
Typical paint stripping compositions including optional ingredients

| | | | | | |
|---|---|---|---|---|---|
| NMP or Alternative | 30-40 | 40-50 | 0 | 10-20 | 30-40 |
| BLO | 50-60 | 0 | 50-60 | 20-30 | 20-30 |
| Propylene Carbonate | 0 | 30-40 | 30-40 | 30-40 | 10-20 |
| EEP | 3-4 | 3-4 | 3-4 | 3-4 | 3-4 |
| Emulphogene ® DA-630¹ | 2-3 | 2-3 | 2-3 | 2-3 | 2-3 |
| Oil of Wintergreen/Thymol | 0.2-0.3 | 0.2-0.3 | 0.2-0.3 | 0.2-0.3 | 0.2-0.3 |
| Denatonium benzoate | 0.002-0.003 | 0.002-0.003 | 0.002-0.003 | 0.002-0.003 | 0.002-0.003 |
| Klucel ® H | 1.15-1.35 | 1.15-1.35 | 1.15-1.35 | 1.15-1.35 | 1.15-1.35 |
| NOP | 1-1.5 | 1-1.5 | 1-1.5 | 1-1.5 | 1-1.5 |
| Silwett L 77 | 0.5-1 | 0.5-1 | 0.5-1 | 0.5-1 | 0.5-1 |

NOP can be replaced by ALCEO or commercial Easy Wet 20
(polyoxyethylated (6) decyl alcohol)

Methodology used to determine the relative efficacy of treatment compositions was extracted from U.S. Pat. No. 5,098,5920 (Incorporated herein by reference to its entirety):

In preliminary screening , one drop of test formulation was applied to 24 inch long, ½ inch high, and 3 inch wide panels of pine wood painted liberally with 3 coats of alkyd enamel paint and cured in air for 1 week and in an oven for 2 days at 50°C. The spots containing the reagents were scrapped of at 15 minutes and 30 minutes intervals and the relative paint stripping performance measured in terms of number of coats removed, 3 being perfect, by visual evaluation.

The efficacy test results is carried carried out on 12 whole panels of wood inter-painted with 4 coats of air cured paint and varnish materials for 8-24 hours. The effectiveness is measured as the percentage of the 4 coats removed after 30 minutes of stripping time with brush application of sufficient test material to cover the surface completely. The coating for the panels is as follows:
Panel 1: Glidden, acrylic latex-white,
Panel 2: Red Devil; acrylic enamel-brown,
Panel 3: Rickel Alkyd enamel-white,
Panel 4: Pittsburgh semigloss latex-white,
Panel 5: Glidden exterior gloss latex-black,
Panel 6: Rickel latex trim exterior gloss-green,
Panel 7: Modern floor deck enamel interior-exterior-brown,
Panel 8: Muralo, acrylic midgloss-white,
Panel 9: Muralo, vinyl-acrylic latex-pink,
Panel 10: Mcloskey gloss polyurethane varnish clear,
Panel 11: Red Devil, gloss polyurethane-enamel-blue,
Panel 12: Sears, interior-exterior latex enamel high gloss-purple.

While the compositions herein have been shown are formulated as solutions, it will be understood that other forms of the inventive compositions may be used as well, such as aerosol sprays, gels, lotions, creams etc.

I claim:

1. A method for removing a coating of paint or varnish from wood or ental surfaces which comprises providing a composition comprising a non-aqueous so vent matrix composed of about 20-70% by weight of a highly polar solvent with a Hansen's fractional polar solubility component greater than 0.25, and an aqueous system additive selected from the group consisting of wetting agents, spreading agents and combinations thereof, the amount of said additive being sufficient to effect the spreading and wetting of the coating to facilitate the removal of the coating from the surface, and applying the composition to the surface to be treated, and then removing the composition from the treated surface

2. The method of claim 1 wherein the highly polar solvent is N-methyl-2-pyrrolidone.

3. The method of claim 1 wherein the additive has an HLB of about 8 or less.

4. The method of claim 1 wherein the additive exhibits a Drave's wetting of a cotton skein in less than 5 seconds at 0.1% water.

5. The method of claim 1 wherein the composition further comprises about 30-80% by weight of gamma-butyrolactone, about 1-30% by weight of ethyl 3-ethoxypmpionate, about 0.1-10% N-octyl pyrrolidone and about 0.1-5% ethoxylated siloxane.

6. The method of claim 1 in which said composition consists essentially of about 30-65% N-methyl-2-pyrrolidone, about 35-70% gamma-butyrolactone, about 2-15% ethyl 3-ethoxypropionate, about 0.2-5% N-octyl pyrrolidone and about 0.2-3% ethoxylated siloxane.

7. The method of claim 1 in which said composition consists essentially of about 35-39% N-methyl-2-pyrrolidone, about 55-59% gamma-butyrolactone, about 3-5% ethyl 3-ethoxypropionate, about 0.5-3% N-octyl pyrrolidone and about 0.5-1% ethoxylated siloxane.

8. A composition which is particularly effective for removing a paint or varnish coating from wood or metal surfaces comprising a non-aqueous solvent matrix about 20-70% by weight of N-methyl-2-pyrrolidone, and an aqueous system additive selected from the group consisting of wetting agents, spreading agents and combinations thereof, the amount of said additive being sufficient to effect its spreading and wetting of the coating to facilitate the removal of the coating from the surface.

9. A composition according to claim 8 wherein the additive has an HLB of about 8 or less than 8.0

10. A composition according to claim 8 wherein the additive exhibits a Drave's wetting of a cotton skein in less than 5 seconds at 0.1% water.

11. A composition according to claim 8 which further comprises about 30-80% by weight of gamma-butyrolactone, about 1-30% by weight of ethyl 3-ethoxypropionate, about 0.1-10% N-octyl pyrrolidone and about 0.1-5% ethoxylated siloxane.

12. A composition which is particularly effective for removing paint and varnish from wood or metal surfaces consisting essentially of (a) about 20 to 70% by weight of N-methyl-2-pyrrolidone; (b) about 30 to 80% by weight of gamma-butyrolactone; (c) about 1 to 30% by weight of ethyl 3-ethoxypropionate; D) about 0.1-10% N-octyl pyrrolidone E) about 0.1-5% ethoxylated siloxane of said composition, and further including one or more compounds selected from the group consisting of (d) a surfactant, (e) a thickener, (f) a flavoring agent, (g) a bittering agent (h) a diluent (i) an organic acid and combinations thereof.

13. A composition according to claim 12 wherein the respective amounts of (a) is 30-65% (b) is 35-70%, (c) is 2-15%. D) is 0.2-5% N-octyl pyrrolidone and E) is 0.2-3% ethoxylated siloxane.

14. A composition according to claim 12 wherein the respective amounts of (a) is 35-39%, (b) is 55-59%, and (c) is 3-5%, D) is 0.5-3% N-octyl pyrrolidone and E) is 0.5-1% ethoxylated siloxane.

15. A composition according to claim 12 wherein the respective amounts of (a) is 37%, (b) is 57%, (c) is 3.5%, D) is 1% and E) is 0.5%.

16. A composition according to claim 121 which includes up to about 5% by wt. of (d), up to about 2% by wt. of (e), up to about 0.5% by wt. of (t) up to about 0.04% by wt. of (g), up to about 40% by wt. of (h) and 2% by wt of (i).

17. A composition according to claim 12 which includes about 2.5% by wt. of (d), about 1.2% by wt. of (e), about 0.25% by wt. of (f), and about 0.0025% by wt. of (g) and 3% by wt of (i).

18. A composition according to claim 12 which includes about 35-39% of (a), about 55-59% of (b), about 3-5% of (c), (D) 0.5-3% of NOP, E) 0.5-1% of ethoxylated Siloxane (ESO) (d)2-3% of polyoxyethylated (6)2-3% of decyl alcohol, (f) 0.2-0.3% of methyl salicylate, (g) 0.002-0.003% of denatonium benzoate (e) 1.15-1.35% of hydroxypropyl cellulose, and (i) 5% of formic acid.
